(19) United States
(12) Patent Application Publication
(10) Pub. No.: US 2026/0001043 A1
(43) Pub. Date: Jan. 1, 2026

(54) FILTRATION MEMBRANES AND METHOD OF MANUFACTURE THEREOF

(71) Applicant: DuPont Electronic Materials International, LLC, Marlborough, MA (US)

(72) Inventors: Sean Muir, Marlborough, MA (US); William Lind, Sudbury, MA (US)

(21) Appl. No.: 18/758,631

(22) Filed: Jun. 28, 2024

(51) Int. Cl. B01D 67/00; B01D 71/26; B01D 71/74

(52) U.S. Cl. CPC B01D 67/0088; B01D 71/26; B01D 71/74

(57) ABSTRACT

A filtration membrane includes a porous membrane that comprises a polymer and a derivatized polydopamine layer disposed on one or both sides of the porous membrane. The derivatized polydopamine layer is disposed on the porous membrane in the presence of an oxidizing agent.

### BACKGROUND

This disclosure relates to filtration membranes and to methods of manufacture thereof. In particular, this disclosure finds applicability in the manufacture of high purity chemicals, which are used in the semiconductor manufacturing industry, as well as in the water, food and pharmaceutical industries.

In the semiconductor manufacturing industry, process chemicals comprising liquids are used throughout the manufacturing process, for example, in lithography, coating, cleaning, stripping, etching and chemical mechanical planarization (CMP) processes. Such chemicals include, for example, acids, solvents, photoresists, antireflective materials, developers, removers, slurries and cleaning solutions. With continued reductions in critical dimensions required for advanced semiconductor devices, it has become increasingly important that the process chemicals be provided in ultrapure form. However, process chemicals even in purified form typically contain trace amounts of metals such as iron, sodium, nickel, copper, calcium, magnesium and potassium, among others. The presence of metals in the process chemicals can be detrimental, resulting, for example, in patterning defects and alteration of electrical properties of the formed devices, thereby impacting device reliability and product yield. The source of such metal impurities can be from raw materials used in the chemical manufacturing process or may otherwise be introduced during the manufacturing and packaging processes.

The reduction of metals and other impurities from process chemicals, raw materials and precursors has conventionally been achieved through the use of ion-exchange and/or filtration processes. Ion exchange purification systems suffer from a number of drawbacks. Many ion exchange resins have functional groups that are chemically aggressive and not compatible with acid sensitive raw materials. The resins are also susceptible to degradation and leaching of organic impurities, which can cause quality issues just as metal impurities do.

It is therefore desirable to develop improved filtration membranes and their methods of making and use, which address one or more problems associated with the state of the art. Additionally, filtration is a necessary part of the process for manufacturing semiconductor-grade chemicals and formulations, in order to remove particulate impurities. A filtration process which can remove both particulate and ionic impurities would be ideal.

### SUMMARY

A filtration membrane includes a porous membrane that comprises a polymer and a derivatized polydopamine layer disposed on one or both sides of the porous membrane. The derivatized polydopamine layer is disposed on the porous membrane in the presence of an oxidizing agent.

A method of coating a porous membrane includes disposing a porous membrane in a solution comprising a dopamine monomer, a buffer, an oxidizing agent and a solvent in a reactor. The dopamine monomer, the buffer and the oxidizing agent are gradually added to the reactor to form a polydopamine layer on the porous membrane. The polydopamine layer is derivatized with an amine, a thiol, a carboxylic acid, or a combination thereof.

A method of purifying a liquid includes passing a liquid through a filtration membrane, where the filtration membrane comprises a porous membrane; a derivatized polydopamine layer disposed on one or both sides of the porous membrane; where the derivatized polydopamine layer is disposed on the porous membrane in the presence of an oxidizing agent. Ionic and particulate impurities are removed from the liquid.

### BRIEF DESCRIPTION OF THE FIGURES

FIGS. 1 to 3 each show bar graphs that depict metal nanoparticle removal for an untreated membrane and one coated with the polydopamine.

### DETAILED DESCRIPTION

The terminology used herein is for the purpose of describing particular embodiments only and is not intended to be limiting of the invention. The singular forms “a”, “an” and “the” are intended to include singular and plural forms, unless the context indicates otherwise.

Auto-polymerization is termed the process whereby monomers form large-chain molecules (i.e., polymers) without the need for a chemical initiator. In this case, dissolved oxygen in the solvent is thought to play a role similar to an initiator in the polymerization process. The process may be accelerated by the addition of a chemical oxidant, which may lead to improved coating.

Nominal pore size refers to the approximate size of the pores in a filter or membrane, indicating the diameter of the pores that the majority of particles are expected to be excluded by. Unlike absolute pore size, which specifies a precise cutoff, nominal pore size is a more generalized indication, often expressed as the size at which a certain percentage of particles (e.g., 90% or 95%) will be retained by the filter.

Disclosed herein are filtration membranes that are coated with a polydopamine or a polydopamine derivative thereof. The polydopamine or its derivatives form a stable coating on one or both surfaces of a membrane. In an embodiment, an oxidizing agent is added to the precursor solution that is used to produce the polydopamine. The use of an oxidizing agent increases the loading of polydopamine on the membrane, which correlates with improved metals removal capacity. In another embodiment, the polydopamine membrane is post-functionalized with an amine. This post-functionalization improves metal removal from contents that contact the membrane. These contents can include, for example, acids, solvents, polymers, photoresists, antireflective materials, developers, removers, slurries and cleaning solutions.

Disclosed herein too is a method of coating one or more surfaces of a membrane with a layer of polydopamine to form a filter, optionally with a step of derivatizing the polydopamine layer. The method comprises dissolving a dopamine-containing monomer and a buffer in solvent to form a reactive solution that is then disposed on one or more surfaces of a membrane to form a coating. The buffer facilitates the polymerization of the dopamine-containing monomer to form polydopamine.

In an embodiment, both opposing surfaces of the membrane may be coated with a layer of the polydopamine to form the filter. The polydopamine layer on one or both surfaces may be derivatized if desired.

### The Membrane

In an embodiment, the membrane may comprise an organic polymer. The organic polymer is preferably thermoplastic, non-aromatic, hydrocarbon polymers which have a linear carbon-to-carbon backbone molecular structure with only non-aromatic substituents and have a plurality of free hydrogen atoms attached to the carbon atoms of the polymer chain. These polymers can be extruded, blown or molded to form the membrane. In an embodiment, the membrane comprises a polyolefin, a fluoropolymer, or a combination thereof. Examples of these thermoplastic extrusion grade or moldable grade organic polymers are homopolymers of ethylene, propylene, isobutylene, methyl-pentene-1, butene-1, vinyl chloride, vinylidene chloride, acrylonitrile, interpolymers of the foregoing monomers with each other, chlorinated polyethylene and chlorinated polypropylene, fluoropolymers such as, for example, polytetrafluoroethylene, perfluoroalkoxy polymers; polyamides, polyimides, polyesters, polystyrene, polysulfone, and blends of the foregoing monomers and copolymers. Of particular interest are the high and low density polyethylene, polypropylene, ethylene/propylene copolymers, ethylene/1-butene copolymers and blends thereof.

In an embodiment, the membrane is porous. The membrane may have a porosity of 10 to 90 volume percent, preferably 30 to 70 volume percent, based on a total volume of the membrane. The membrane has nominal pore sizes of 0.5 nanometers to 5 micrometers, preferably 5 nanometers to 200 nanometers. These “nominal” pore sizes are determined through a method such as bubble point or nanoparticle retention testing.

### Preparation of the Reactive Solution

The reaction to form the polydopamine may be conducted in a reactor into which the membrane is then immersed. The reactants (the dopamine-containing monomer and the buffer) along with the solvent are preferably added directly to the reactor where they undergo a reaction to form the polydopamine coating.

The polydopamine layer is prepared by polymerizing a dopamine-containing monomer in a reactive solution using a buffer. The dopamine-containing monomer, the buffer, the solvent, the oxidizing agent and any additional components are added to a reactor to form the reactive solution. The dopamine-containing monomer undergoes auto-polymerization to form polydopamine.

The dopamine-containing monomer is typically in the form of a salt. In such case, the dopamine preferably exists in its protonated form with a halide counterion, for example, a Cl-, Br-, F- or I-counterion. In a preferred embodiment, the dopamine-containing monomer is dopamine hydrochloride.

The dopamine-containing monomer is typically present in the reactive solution in an amount of 0.01 to 10 weight percent (wt %) based on the total weight of the reactive solution. The dopamine-containing monomer is preferably present in the reactive solution in an amount of 0.02 to 5 wt %, from 0.02 to 1 wt %, or from 0.05 to 0.20 wt % based on the total weight of the reactive solution.

The buffer is primarily used to adjust the pH of the solution to be in a range that facilitates auto-polymerization of the dopamine-containing monomer. The buffer preferably has a pKa between 7.0 and 9.0.

Examples of the buffer include tris buffer (tris(hydroxymethyl)aminomethane), sodium dihydrogen phosphate, potassium dihydrogen phosphate, or a combination thereof. Tris buffer (tris(hydroxymethyl)aminomethane) is a preferred buffer. However, it may be substituted for any other buffer with a pKa between 7.0 and 9.0, such as sodium dihydrogen phosphate or potassium dihydrogen phosphate.

The buffer is typically present in the reactive solution in an amount of 0.01 to 5 wt % based on the total weight of the reactive solution. The buffer is preferably present in the reactive solution in an amount of 0.01 to 3 wt %, 0.05 to 1 wt %, or 0.10 to 0.30 wt % based on the total weight of the reactive solution.

The oxidizing agent facilitates an increase in the amount polydopamine that is disposed on the membrane surface, especially when compared with a reactive solution that does not contain the oxidizing agent. This presence of increased dopamine leads to an improved metal removal capacity from solutions that contact the membrane. Oxidizing agents are preferably water soluble and include, for example, hydrogen peroxide, organic peroxides, nitrates, permanganates, periodates, persulfates, dichromates, chlorates, perborates, or a combination thereof. Examples of suitable oxidizing agents include alkali metaperiodates (e.g., sodium metaperiodate, potassium metaperiodate, lithium metaperiodate, or a combination thereof), alkali perchlorates (e.g., lithium perchlorate, sodium perchlorate, potassium perchlorate, or a combination thereof), ammonium salts (e.g., ammonium persulfate, ammonium nitrate, ammonium dichromate, ammonium persulfate, ammonium perchlorate, ammonium periodate, or a combination thereof), or a combination thereof.

In an embodiment, a controlled, gradual addition of the oxidizing agent to the reactive solution may give an improved coating of the membrane compared with adding the oxidizing agent to the reactive solution all at once. This is because the oxidizing agent greatly accelerates the coating reaction, which can result in the formation of polydopamine particles in solution rather than being deposited on the membrane. By adding the oxidizing agent gradually, the rate of the reaction can be controlled so as to maximize the amount of polydopamine coated on the filter membrane.

In an embodiment, one or more of the dopamine monomer, the buffer and the oxidizing agent may be added gradually to the reactive solution. Excessive reagent concentration (particularly of the oxidizing agent) can result in very rapid polydopamine formation, leading to the precipitation of small polydopamine particles in solution. This reduces the amount of polydopamine which is successfully coated on the membrane. The gradual addition of one or more of the dopamine monomer, the buffer and the oxidizing agent maintains the concentration of the reagents in the optimal range, so as to maximize the slow, controlled deposition of the polydopamine on the membrane, and minimize rapid particle formation.

In an embodiment, the buffer and dopamine containing monomer are added to the reactor over 1 to 12 hours, preferably 4 to 8 hours. In another embodiment, the oxidizing agent is added to the reactor over a period of 2 to 24 hours, preferably 12 to 16 hours.

In an embodiment, the molar ratio of the electrons accepted by the oxidizing agent (if used) to the dopamine-containing monomer donating the electrons is 2:1 to 8:1, preferably 3:1 to 5:1. The oxidizing agent, if used, is typically present in the solution in an amount of 0.001 wt % to 10 wt % based on the total weight of the reactive solution. More preferably, it is in an amount of 0.01 wt % to 5 wt %, from 0.1 to 0.5 wt % based on the total weight of the reactive solution.

The solvent present in the reactive solution should be capable of dissolving the dopamine-containing monomers and any other solid components of the solution. The solvent forms the balance of the reactive solution. Examples of suitable solvents are water, organic solvents such as an alcohol, or a combination thereof. Particularly preferred solvents include ethanol and/or water.

The solvent is typically present in the reactive solution in an amount of 90 to 99.99 wt % based on the total weight of the reactive solution. The solvent is preferably present in the reactive solution in an amount of 95 to 99.99 wt %, 98 to 99.90 wt %, or 99.50 to 99.85 wt % based on the total weight of the reactive solution.

In an embodiment, the dopamine monomer, the oxidizing agent and the buffer (which adjusts the pH to the range in which the dopamine will auto-polymerize) and any additional components are dissolved in the solvent in a reactor to form the reaction solution. A change in color indicates that the auto-polymerization has begun. For example, it has been observed that the color changes to light orange and then begins to darken, eventually becoming black indicating that polymerization to a high molecular weight polydopamine has occurred. The reaction solution is subjected to agitation for a period of 0.5 hours to 96 hours, preferably 5 to 80 hours, and more preferably 10 to 30 hours at a temperature of 10 to 50° C., preferably 18 to 40° C. to form a polydopamine-coating solution.

The membrane that is to be coated with the polydopamine layer is preferably hydrophobic and needs to be pre-wetted with a water-miscible organic solvent after which it is flushed (e.g., rinsed) with water to remove the solvent. Examples of such water-miscible solvents are alcohols (e.g., methanol, ethanol, isopropanol, ethylene glycol, or a combination thereof), ketones (e.g., acetone, methyl ethyl ketone, cyclohexanone, or a combination thereof), acetonitrile, dimethyl sulfoxide, tetrahydrofuran, glycerol, N-methyl-2-pyrrolidone, or the like, or a combination thereof.

After flushing with water, the membrane is immersed into the polydopamine-containing solution in the reactor or other container. The membrane may be introduced into the reactive solution as soon as the ingredients are mixed together or at any time after auto-polymerization has begun. The polydopamine-containing solution contacts the membrane for 2 to 20 hours, preferably 8 to 19 hours, and more preferably 12 to 16 hours to facilitate the deposition of polydopamine on the membrane. The membrane after coating is called a polydopamine-coated membrane.

In an embodiment, both sides of the membrane may be coated with the polydopamine. In another embodiment, one side of the membrane may be covered with a removable mask prior to the immersion into the reactive solution. After the polydopamine layer is disposed on the membrane, the mask may be removed thus permitting the membrane to be coated on only one surface. The polydopamine in the container or reactor may be gently agitated during this coating process. When the deposition is complete, the remaining solution is discarded, leaving the polydopamine-coated membrane behind. The polydopamine-coated membrane is washed with water to remove all traces of the reaction solution and other loose particles from the membrane.

### Derivatization of the Polydopamine

In an embodiment, the polydopamine-coated membrane can be functionalized after polymerization to form a polydopamine derivative. Derivatized polydopamines may show improved effectiveness for removing metals from the contents of the container. Functionalizing agents that may be used to functionalize the polydopamine include, for example, primary amines, secondary amines, tertiary amines, moieties containing carboxylic acids that are functionalized with amines and/or thiols or a combination thereof. The amines may, for example, be linear or cyclic amines. Preferred amines are primary amines, secondary amines, or a combination thereof.

Examples of primary amines include methylamine, ethylamine, propylamine, ethylenediamine, monoethanolamine, and the like, or a combination thereof. Examples of secondary amines include dialkylamines such as dimethylamine, diethylamine, dipropylamine, dibutylamine, diethanolamine, and the like, or a combination thereof.

In an embodiment, amine-functionalized carboxylic acids may be used as functionalizing agents. The carboxylic acid present in these functionalizing agents facilitate additional metal removal capabilities compared with functionalizing agents that include only primary or secondary amines. Examples include aminopolycarboxylic acids (APCAs) such as iminodiacetic acid, aspartic acid, ethylenediaminetetraacetic acid, hyaluronic acid, and the like, or a combination thereof.

In an embodiment, the polydopamine may be derivatized with functionalizing agents that comprise a thiol and a carboxylic acid. An example of a functionalizing agent that contains both thiol and carboxylic acid is mercaptosuccinic acid. Functionalizing agents that contain both thiol and amines may also be used to facilitate metal removal from the contents of the container.

In an embodiment, amine and/or thiol-containing functionalizing agents that comprise a sulfonic acid group may also be used to facilitate metal removal from the contents of the container. An example of such a functionalizing agent is sulfamic acid, 3-mercapto-1-propanesulfonic acid, or a combination thereof.

The amine may be added to an amination solution, wholly or partly, in the form of a hydrochloride salt rather than the free base. For example, dimethylamine hydrochloride may be used in place of dimethylamine, or more preferably, a mixture of the two (dimethylamine and dimethylamine hydrochloride), in order to adjust the pH to the desired range.

In a preferred embodiment, during the functionalization of the polydopamine coated membrane, an acid is added to an amination solution (if an amine is used for functionalization of the polydopamine coating) to adjust the pH to the optimal range. The pH adjustment allows a higher concentration of amine to be used, which would otherwise result in an excessively high pH and dissolution of the polydopamine coating if not for the adjustment. The acid may be a mineral acid such as hydrochloric acid, but it may also be an aminocarboxylic acid, aminophosphonic acid, or aminosulfonic acid, all of which will provide additional functionality to the membrane by co-depositing with the free base amine.

Derivatization of the polydopamine coating is preferably conducted after formation of the polydopamine coating on the membrane. The functionalizing agent can be dissolved in a second solvent prior to the polydopamine coated membrane being immersed in it. The second solvent is preferably water, an alcohol or a combination thereof. A preferred alcohol is ethanol. The preferred second solvent is water.

In an embodiment, the functionalizing agent is present in the solution in an amount of 0.01 to 10 wt %, based on the total weight of the functionalization solution. In another embodiment, the functionalizing agent is present in the solution in an amount of 0.5 to 5.0 wt %, based on the total weight of the functionalization solution.

In a preferred embodiment, the membrane with the polydopamine coating disposed thereon is then subjected to exposure to an amine. Amination of the polydopamine coating is optional but provides a substantial improvement in metals removal performance. The polydopamine-coated membrane is immersed in an aqueous solution of amine and agitated for 12-16 hours. The amine was found to give a significant improvement in metals removal performance is dimethylamine.

An optional acid washing step may be used to remove residual metals which may impair the performance of the membrane. The membrane is immersed in a dilute solution of aqueous acid (e.g. hydrochloric acid), which is preferably trace metal grade, and agitated for several hours. A water miscible alcohol, such as isopropyl alcohol, may be used as a co-solvent. The acid washing step may be carried out after the polydopamine coating step, after the amination step, or after both steps.

Following the acid washing step, the membrane may be thoroughly washed with water before it is used. If the membrane is to be used to purify a non-aqueous solvent or formulation, the residual water should be removed, either by drying at high temperature or by flushing with the non-aqueous solvent to displace the water. A drying/thermal curing step may optionally be conducted after the water washing step, which will improve the stability of the derivatized coating. The membrane is dried at 50 to 100° C., more preferably at 70 to 80° C. The length of the drying step is 2 to 16 hours, or more preferably 3 to 12 hours. In an embodiment, the drying step is carried out under vacuum, at an absolute pressure of 0.001 to 0.50 atmospheres, or more preferably 0.005 to 0.10 atmospheres.

Derivatized polydopamine coatings can display a greater overall ability to extract ionic impurities from solutions that are filtered using the polydopamine-coated membrane. In an embodiment, the derivatized polydopamine coatings can extract at least 5 wt % more, preferably at least 10 wt % more, and more preferably 15 wt % more ionic impurities than an underivatized polydopamine coating of the same thickness.

The membrane may then be used in a filtration process to remove ionic impurities in a fluid that is passed through the membrane. Dead-end filtration (which is where the fluid flows directly into the membrane at a right-angle) and cross-flow filtration (which is where the fluid is passed tangentially across the membrane surface) can be used to effect ion particle and nanoparticle removal.

The polydopamine and the derivatized polydopamine coatings detailed herein along with the methods of manufacturing them are exemplified by the following non-limiting examples.

### EXAMPLES

### Example 1

An ultra-high molecular weight polyethylene (UPE) membrane coupon (having a diameter of 47 mm with a nominal pore size of 50 nanometers (nm)) was weighed to determine the baseline mass (25.4 mg), placed inside a PFA (perfluoroalkoxy) filter holder, and flushed with 200 g of isopropyl alcohol (IPA) at a rate of approximately 3 g/min. The filter holder is a grid with holes of 1-2 mm diameter for the fluid to pass through and retained inside a PFA housing with inlet and outlet ports for fluid flow. This was followed by flushing with 200 grams of deionized (DI) water to displace the IPA. The filter membrane coupon was then removed and placed inside a 120 mL low density polyethylene (LDPE) bottle, to which was added 112.06 g of DI water, 4.09 g of a 15 mg/mL solution of tris buffer (tris(hydroxymethyl)aminomethane), and 4.03 g of a 15 mg/mL solution of dopamine hydrochloride. The bottle was placed on a roller and rolled overnight before removing the membrane, washing several times with DI water, and drying in a vacuum oven at 50° C. The final mass was 26.8 mg, indicating that 1.4 mg of polydopamine had been coated onto the membrane.

After rewetting the polydopamine coated membrane with propylene glycol methyl ether acetate (PGMEA), it was placed back inside the filter holder and flushed with a solution of PGMEA spiked (hereinafter spiked PGMEA) with a custom multi-element standard containing ions of Al, Ca, Cr, Cu, Fe, Mg, Mn, Ni, K, Na, Sn, Ti, and Zn of at a flow rate of 1.5 g/min. Samples of the spiked PGMEA were collected after 5 minutes, 40 minutes, and 75 minutes of continuous flushing and analyzed for metals content using an Agilent 7700 Single Quadrupole inductively coupled plasma-mass spectrometer (ICP-MS). The spiked PGMEA is flushed through the filter continuously, without recirculation. The 5, 40, and 75 minute samples are collected from the membrane outlet.

The results in parts per billion (ppb) are shown in Table 1 along with those of a control sample of the spiked PGMEA. The results show that there is a smaller amount of each metal in the sample (as compared with the control) with the passage of time.

TABLE 1

| Metal | Control | 5 minutes | 40 minutes | 75 minutes |
|---|---|---|---|---|
| Al | 7.752 | 5.453 | 7.100 | 6.827 |
| Ca | 7.230 | 7.284 | 7.441 | 7.875 |
| Cr | 8.045 | 6.331 | 8.168 | 8.284 |
| Cu | 7.056 | 5.304 | 7.186 | 7.785 |
| Fe | 6.603 | 8.008 | 7.601 | 7.620 |
| Mg | 7.822 | 5.235 | 7.311 | 7.351 |
| Mn | 7.414 | 4.590 | 6.584 | 7.037 |
| Ni | 7.787 | 4.247 | 5.712 | 6.089 |
| K | 7.523 | 5.423 | 7.657 | 7.820 |
| Na | 8.269 | 6.485 | 8.589 | 8.538 |
| Sn | 4.679 | 3.453 | 4.510 | 4.463 |
| Ti | 2.710 | 1.866 | 2.360 | 2.229 |
| Zn | 7.737 | 5.612 | 7.100 | 7.211 |
| TOTAL | 90.627 | 69.291 | 87.319 | 89.129 |

### Example 2

An ultra-high molecular weight polyethylene (UPE) membrane coupon (having a diameter of 47 mm with a nominal pore size of 50 nanometers (nm)) was weighed to determine the baseline mass (25.7 mg). It was then placed inside a PFA filter holder and flushed with IPA and water in the same manner as described in Example 1. The filter membrane coupon was then removed and placed inside a 120 mL LDPE bottle, to which was added 72.06 g of DI water, 4.07 g of a 15 mg/mL solution of the same tris buffer as in Example 1, 4.01 g of a 15 mg/mL solution of dopamine hydrochloride and 40.09 g of a 6 mg/mL solution of sodium metaperiodate. The bottle was placed on a roller and rolled overnight before removing the membrane, washing several times with DI water, and drying in a vacuum oven at 50° C. The final mass was 34.5 mg, indicating that 8.8 mg of polydopamine had been coated onto the membrane.

After rewetting the membrane with propylene glycol methyl ether acetate (PGMEA), it was placed back inside the filter holder and flushed with the solution of spiked PGMEA (described in Example 1) at a flow rate of 1.5 g/min. Samples of the spiked PGMEA were collected after 9 minutes, 40 minutes, and 76 minutes of continuous flushing, and analyzed for metals content using an Agilent 7700 Single Quadrupole inductively coupled plasma-mass spectrometer (ICP-MS). The results for a control sample of the spiked PGMEA along with those obtained after the continuous flushing are shown below in Table 2. The results are in parts per billion (ppb).

TABLE 2

| Metal | Control | 9 minutes | 40 minutes | 76 minutes |
|---|---|---|---|---|
| Al | 7.752 | 3.625 | 5.454 | 5.625 |
| Ca | 7.230 | 1.038 | 8.391 | 4.222 |
| Cr | 8.045 | 4.938 | 6.905 | 6.902 |
| Cu | 7.056 | 1.860 | 2.808 | 3.649 |
| Fe | 6.603 | 4.918 | 6.649 | 6.861 |
| Mg | 7.822 | 0.426 | 2.537 | 4.489 |
| Mn | 7.414 | 0.276 | 0.360 | 0.387 |
| Ni | 7.787 | 0.421 | 0.563 | 0.543 |
| K | 7.523 | 0.466 | 0.420 | 0.528 |
| Na | 8.269 | 0.421 | 1.560 | 2.885 |
| Sn | 4.679 | 2.612 | 3.514 | 3.579 |
| Ti | 2.710 | 1.128 | 1.732 | 1.724 |
| Zn | 7.737 | 0.366 | 0.395 | 0.910 |
| TOTAL | 90.627 | 22.495 | 41.288 | 42.304 |

### Example 3

An ultra-high molecular weight polyethylene (UPE) membrane coupon (having a diameter of 47 mm with a nominal pore size of 50 nanometers (nm)) was weighed to determine the baseline mass (24.3 mg). It was then placed inside a PFA filter holder and flushed with IPA and water in the same manner as described in Example 1. The filter membrane coupon was then removed and placed inside a 120 mL LDPE bottle, to which was added 112.10 g of DI water, 4.04 g of a 15 mg/mL solution of the tris buffer of Example 1 and 4.03 g of a 15 mg/mL solution of dopamine hydrochloride. The bottle was placed on a roller overnight, after which the polydopamine coated membrane was removed and washed with DI water. The polydopamine coated membrane was then subjected to functionalization (amination) by placing back in the bottle along with 120.04 g of aqueous solution containing 20 mg/mL dimethylamine (Fisher Scientific) and 0.5 mg/mL of tris buffer, adjusted to pH 10 using hydrochloric acid. The bottle was placed on a roller and rolled overnight before removing the membrane, washing the functionalized polydopamine coated membrane several times with DI water, and drying the coated membrane in a vacuum oven at 50° C. The final mass was 24.4 mg, indicating that 0.1 mg of the polydopamine coating remained on the membrane.

After rewetting the membrane with propylene glycol methyl ether acetate (PGMEA), it was placed back inside the filter holder and flushed with a solution of PGMEA spiked with 10 ppb per metal of the custom multi-element standard described in Example 1 at a flow rate of 1.5 g/min. Samples were collected after 5 minutes, 40 minutes, and 75 minutes, and analyzed for metals content using an Agilent 7700 Single Quadrupole inductively coupled plasma-mass spectrometer (ICP-MS). The results for a control sample of the spiked PGMEA along with those obtained after the continuous flushing are shown below in Table 3. The results are in parts per billion (ppb).

TABLE 3

| Metal | Control | 5 minutes | 40 minutes | 75 minutes |
|---|---|---|---|---|
| Al | 7.185 | 2.197 | 5.752 | 5.772 |
| Ca | 10.989 | 0.226 | 18.027 | 17.127 |
| Cr | 9.564 | 3.135 | 6.837 | 7.153 |
| Cu | 9.903 | 2.668 | 4.201 | 5.533 |
| Fe | 10.656 | 5.577 | 8.236 | 8.414 |
| Mg | 9.797 | 0.060 | 7.529 | 8.169 |
| Mn | 9.782 | 0.025 | 0.050 | 0.264 |
| Ni | 9.372 | 0.130 | 0.303 | 0.339 |
| K | 9.827 | 0.722 | 10.463 | 11.484 |
| Na | 10.338 | 3.029 | 10.836 | 10.432 |
| Sn | 5.325 | 0.667 | 2.434 | 2.786 |
| Ti | 2.117 | 0.115 | 0.939 | 0.817 |
| Zn | 14.147 | 0.311 | 1.560 | 1.914 |
| TOTAL | 119.002 | 18.862 | 77.168 | 80.205 |

### Example 4

An ultra-high molecular weight polyethylene (UPE) membrane filter membrane coupon (having a diameter of 47 mm with a nominal pore size of 50 nanometers (nm)) was weighed to determine the baseline mass (24.9 mg). It was then placed inside a PFA filter holder and flushed with IPA and water in the same manner as described in Example 1. The filter membrane coupon was then removed and placed inside a 120 mL LDPE bottle, to which was added 72.09 g of DI water, 4.01 g of a 15 mg/mL solution of tris buffer (Fisher Scientific), 4.04 g of a 15 mg/mL solution of dopamine hydrochloride (Fisher Scientific), and 40.01 g of a 6 mg/mL solution of sodium metaperiodate (Fisher Scientific). The bottle was placed on a roller overnight, after which the membrane was removed and washed with DI water. It was then functionalized by placing it back in the bottle along with 120.08 g of aqueous solution containing 20 mg/mL dimethylamine (Fisher Scientific) and 0.5 mg/mL of tris buffer, adjusted to pH 10 using hydrochloric acid. The bottle was placed on a roller and rolled overnight before removing the membrane, washing several times with DI water, and drying in a vacuum oven at 50° C. The final mass was 30.3 mg, indicating that 5.4 mg of coating remained on the membrane.

After rewetting the polydopamine coated membrane with propylene glycol methyl ether acetate (PGMEA), it was placed back inside the filter holder and flushed with a solution of PGMEA spiked (hereinafter spiked PGMEA) with a custom multi-element standard containing ions of Al, Ca, Cr, Cu, Fe, Mg, Mn, Ni, K, Na, Sn, Ti, and Zn of at a flow rate of 1.5 g/min. Samples of the spiked PGMEA were collected after 5 minutes, 40 minutes, and 75 minutes of continuous flushing and analyzed for metals content using an Agilent 7700 Single Quadrupole inductively coupled plasma-mass spectrometer (ICP-MS). The results for a control sample of the spiked PGMEA along with those obtained after the continuous flushing are shown below in Table 4. The results are in parts per billion (ppb).

TABLE 4

| Metal | Control | 5 minutes | 40 minutes | 75 minutes |
|---|---|---|---|---|
| Al | 7.185 | 1.040 | 1.482 | 2.022 |
| Ca | 10.989 | 0.380 | 0.710 | 3.514 |
| Cr | 9.564 | 3.360 | 4.813 | 5.417 |
| Cu | 9.903 | 4.225 | 3.311 | 3.144 |
| Fe | 10.656 | 8.424 | 8.849 | 9.016 |
| Mg | 9.797 | 0.050 | 0.051 | 0.050 |
| Mn | 9.782 | 0.015 | 0.015 | 0.015 |
| Ni | 9.372 | 0.065 | 0.097 | 0.080 |
| K | 9.827 | 0.120 | 0.112 | 1.317 |
| Na | 10.338 | 0.180 | 1.277 | 4.576 |
| Sn | 5.325 | 0.420 | 0.761 | 0.846 |
| Ti | 2.117 | 0.135 | 0.133 | 0.350 |
| Zn | 14.147 | 1.800 | 1.410 | 1.497 |
| TOTAL | 119.002 | 20.214 | 23.021 | 31.844 |

### Example 5

An ultra-high molecular weight polyethylene (UPE) membrane filter membrane coupon (having a diameter of 47 mm with a nominal pore size of 50 nanometers (nm)) was weighed to determine the baseline mass (27.7 mg). It was then placed inside a PFA filter holder and flushed with IPA and water in the same manner as described in Example 1. The filter membrane coupon was then removed and placed inside a 120 mL LDPE bottle, along with 0.404 g of dopamine hydrochloride, 0.163 g of the tris base (of Example 1), and 135.20 g of DI water. The bottle was placed on a roller and rolled overnight before removing the membrane, washing several times with DI water, and drying in a vacuum oven at 50° C. The membrane was visibly darker in color than before coating. The final mass was 38.3 mg, indicating that 10.6 mg of polydopamine had been coated onto the membrane.

A dispersion of maleic anhydride-functionalized iron (II,III) oxide nanoparticles (30 nm, Sigma Aldrich) was diluted to 10 ppb in a 0.1% aqueous solution of Triton X-100 surfactant (Dow). The dispersion was passed through the coated membrane at 0.6 g/min. After collecting a sample, the remaining dispersion (approximately 400 g) was recirculated through the filter for 22 hours (equating to approximately 2 tank turnovers) before collecting another sample at the filter holder outlet. The experiment was repeated using an untreated UPE membrane.

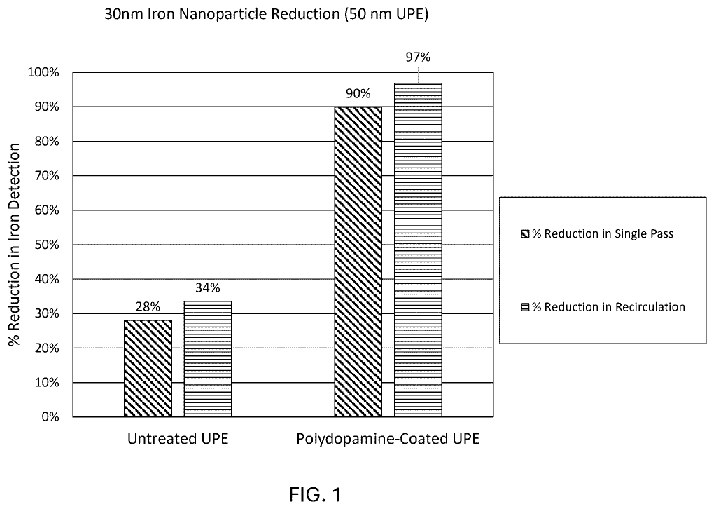

The iron content of the samples was determined by ICP-MS and compared to an unfiltered control sample to determine the percent removal of the nanoparticles. The results are shown in the FIG. 1. FIG. 1 is a bar graph that shows the iron nanoparticle removal for an untreated UPE membrane and with a polydopamine coated membrane.

### Example 6

An ultra-high molecular weight polyethylene (UPE) membrane filter membrane coupon (having a diameter of 47 mm with a nominal pore size of 20 nanometers (nm)) was weighed to determine the baseline mass (32.3 mg). It was then placed inside a PFA filter holder and flushed with IPA and water in the same manner as described in Example 1. The filter membrane coupon was then removed and placed inside a 120 mL LDPE bottle, along with 0.405 g of dopamine hydrochloride, 0.168 g of the tris base of Example 1 and 135.01 g of DI water. The bottle was placed on a roller and rolled overnight before removing the membrane, washing several times with DI water, and drying in a vacuum oven at 50° C. The final mass of the polydopamine coated membrane was 41.7 mg, indicating that 9.4 mg of polydopamine had been coated onto the membrane.

A dispersion of maleic anhydride-functionalized iron (II,III) oxide nanoparticles (having an average particle size of 30 nm) was diluted to 10 ppb in a 0.1% aqueous solution of Triton X-100 surfactant (Dow). The dispersion was passed through the coated membrane at 0.6 g/min. After collecting a sample, the remaining dispersion (approximately 400 g) was recirculated through the filter for 22 hours before collecting another sample at the filter holder outlet. The experiment was repeated using an untreated comparative UPE membrane.

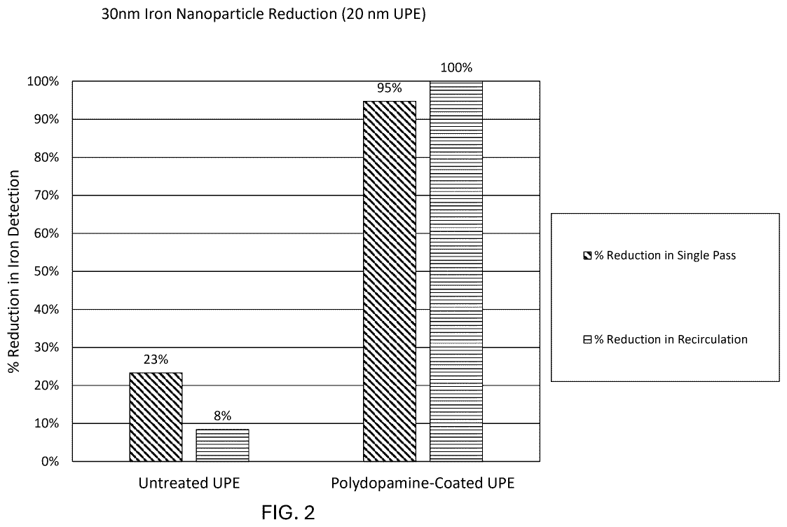

The iron content of the samples was determined by ICP-MS (as detailed in the Example 1) and compared to an unfiltered control sample to determine the percent removal of the nanoparticles. The results are shown in the FIG. 2. FIG. 2 is a bar graph that shows the iron nanoparticle removal reduction for an untreated UPE membrane and one coated with the polydopamine.

### Example 7

An ultra-high molecular weight polyethylene (UPE) membrane coupon (having a diameter of 47 mm with a nominal pore size of 10 nanometers (nm)) was weighed to determine the baseline mass (32.4 mg). It was then placed inside a PFA filter holder and flushed with IPA and water in the same manner as described in Example 1. The filter membrane coupon was then removed and placed inside a 120 mL LDPE bottle, along with 0.404 g of dopamine hydrochloride, 0.162 g of tris base and 135.46 g of DI water. The bottle was placed on a roller and rolled overnight before removing the membrane, washing several times with DI water, and drying in a vacuum oven at 50° C. The final mass was 43.8 mg, indicating that 11.4 mg of polydopamine was coated onto the membrane.

A dispersion of maleic anhydride-functionalized iron (II,III) oxide nanoparticles (average particle size of 30 nm) was diluted to 10 ppb in a 0.1% aqueous solution of Triton X-100 surfactant (Dow). The dispersion was passed through the coated membrane, initially at 0.6 g/min, but reduced to 0.2 g/min due to a high pressure drop (˜26 psig). After collecting a sample, the remaining dispersion (approximately 400 g) was recirculated through the filter for 70 hours before collecting another sample at the filter holder outlet. The experiment was repeated using an untreated comparative UPE membrane.

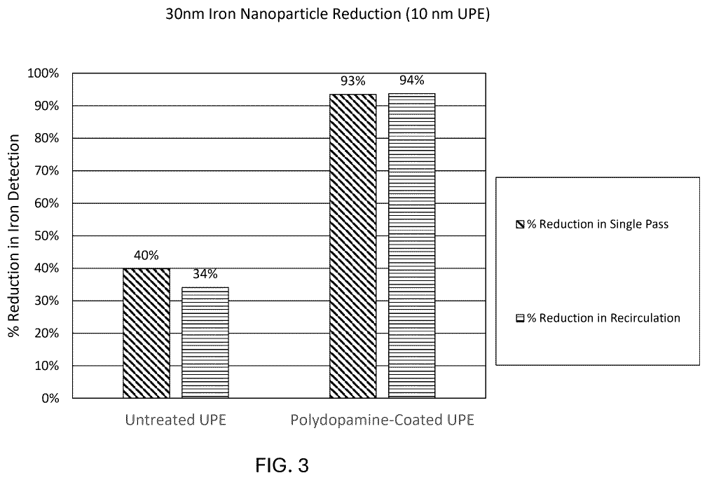

The iron content of the samples was determined by ICP-MS and compared to an unfiltered control sample to determine the percent removal of the nanoparticles. The results are shown in the FIG. 3. FIG. 3 is a bar graph that shows the iron nanoparticle removal for an untreated UPE membrane and one coated with the polydopamine.

### Example 8

An ultra-high molecular weight polyethylene (UPE) membrane coupon (having a diameter of 47 mm with a nominal pore size of 30 nanometers (nm)) was weighed to determine the baseline mass (28.1 mg). It was then placed inside a PFA filter holder and flushed with IPA and water in the same manner as described in Example 1. The filter membrane coupon was then removed and placed inside a 120 mL LDPE bottle, to which was added 48.26 g of DI water, 6.00 g of a 15 mg/mL solution of the tris buffer (see Example 1), 5.99 g of a 15 mg/mL solution of dopamine hydrochloride, and 60.38 g of a 28 mmol/L solution of sodium metaperiodate. The bottle was placed on a roller overnight, after which the membrane was removed and washed with DI water. It was then placed back in the bottle along with 120.21 g of aqueous solution containing 20 mg/mL dimethylamine and 0.5 mg/mL of tris buffer, adjusted to pH 10 using hydrochloric acid. The bottle was placed on a roller and rolled overnight before removing the membrane, washing several times with DI water, and drying in a vacuum oven at 50° C. The final mass was 38.6 mg, indicating that 10.5 mg of coating remained on the membrane.

After rewetting the membrane with propylene glycol methyl ether acetate (PGMEA), it was placed back inside the filter holder and flushed with a solution of PGMEA spiked with 10 ppb per metal of the custom multi-element standard described in Example 1 at a flow rate of 1.5 g/min. Samples were collected after 8 minutes, 42 minutes, 77 minutes and 112 minutes, and analyzed for metals content using an Agilent 7700 Single Quadrupole inductively coupled plasma-mass spectrometer (ICP-MS), along with a control sample of the spiked PGMEA. The results, in ppb, are shown in the Table 5 below.

TABLE 5

| Metal | Control | 8 minutes | 42 minutes | 77 minutes | 112 minutes |
|---|---|---|---|---|---|
| Al | 7.557 | 0.427 | 0.665 | 0.811 | 0.987 |
| Ca | 7.657 | 0.015 | 0.358 | 1.190 | 0.106 |
| Cr | 7.542 | 0.487 | 0.822 | 0.991 | 1.133 |
| Cu | 6.132 | 0.080 | 0.096 | 0.100 | 0.136 |
| Fe | 6.388 | 0.181 | 0.368 | 0.453 | 0.529 |
| Mg | 7.216 | 0.000 | 0.000 | 0.000 | 0.000 |
| Mn | 7.025 | 0.010 | 0.015 | 0.035 | 0.015 |
| Ni | 6.589 | 0.010 | 0.010 | 0.015 | 0.020 |
| K | 8.460 | 0.241 | 0.060 | 0.040 | 0.030 |
| Na | 6.699 | 0.060 | 0.086 | 0.090 | 0.106 |
| Sn | 4.712 | 0.196 | 0.343 | 0.423 | 0.514 |
| Ti | 2.685 | 0.080 | 0.131 | 0.159 | 0.186 |
| Zn | 6.980 | 0.040 | 0.050 | 0.060 | 0.071 |
| TOTAL | 85.642 | 1.828 | 3.005 | 4.367 | 3.834 |

### Example 9

An ultra-high molecular weight polyethylene (UPE) membrane coupon (having a diameter of 47 mm with a nominal pore size of 30 nanometers (nm)) was weighed to determine the baseline mass (28.7 mg). It was then placed inside a PFA filter holder and flushed with IPA and water in the same manner as described in Example 1. The filter membrane coupon was then removed and placed inside a 120 mL LDPE bottle to which was added 48.05 g of DI water, 6.06 g of a 15 mg/mL solution of the tris buffer, 6.03 g of a 15 mg/mL solution of dopamine hydrochloride and 60.25 g of a 28 mmol/L solution of ammonium persulfate. The bottle was placed on a roller overnight, after which the membrane was removed and washed with DI water. It was then placed back in the bottle along with 120.11 g of aqueous solution containing 20 mg/mL dimethylamine and 0.5 mg/mL of tris buffer, adjusted to pH 10 using hydrochloric acid. The bottle was placed on a roller and rolled overnight before removing the membrane, washing several times with DI water, and drying in a vacuum oven at 50° C. The final mass was 30.8 mg, indicating that 2.1 mg of coating remained on the membrane.

After rewetting the membrane with propylene glycol methyl ether acetate (PGMEA), it was placed back inside the filter holder and flushed with a solution of PGMEA spiked with 10 ppb per metal of the custom multi-element standard described in Example 1 at a flow rate of 1.4 g/min. Samples were collected after 5 minutes, 60 minutes, and 108 minutes, and analyzed for metals content using an Agilent 7700 Single Quadrupole inductively coupled plasma-mass spectrometer (ICP-MS), along with a control sample of the spiked PGMEA. The results, in ppb, are shown in Table 6.

TABLE 6

| Metal | Control | 5 minutes | 60 minutes | 109 minutes |
|---|---|---|---|---|
| Al | 6.919 | 0.091 | 0.081 | 0.125 |
| Ca | 16.871 | 0.671 | 0.327 | 0.986 |
| Cr | 10.238 | 0.293 | 0.785 | 1.016 |
| Cu | 9.264 | 0.050 | 0.050 | 0.040 |
| Fe | 7.994 | 0.066 | 0.171 | 0.300 |
| Mg | 11.699 | 0.000 | 0.000 | 0.000 |
| Mn | 11.905 | 0.005 | 0.005 | 0.005 |
| Ni | 9.861 | 0.000 | 0.000 | 0.050 |
| K | 12.824 | 1.342 | 0.337 | 1.482 |
| Na | 13.813 | 1.735 | 0.448 | 1.242 |
| Sn | 4.223 | 0.010 | 0.015 | 0.025 |
| Ti | 2.400 | 0.000 | 0.000 | 0.000 |
| Zn | 9.560 | 0.182 | 0.297 | 0.135 |
| TOTAL | 127.571 | 4.446 | 2.516 | 5.406 |

### Example 10

An ultra-high molecular weight polyethylene (UPE) membrane coupon (having a diameter of 47 mm with a nominal pore size of 30 nanometers (nm)) was weighed to determine the baseline mass (25.6 mg). It was then placed inside a PFA filter holder and flushed with IPA and water in the same manner as described in Example 1. The filter membrane coupon was then removed and placed inside a 120 mL LDPE bottle, to which was added 48.07 g of DI water, 6.03 g of a 15 mg/mL solution of the tris buffer (of Example 1), 6.03 g of a 15 mg/mL solution of dopamine hydrochloride and 60.02 g of a 28 mmol/L solution of lithium perchlorate (the oxidizing agent). The bottle was placed on a roller overnight, after which the membrane was removed and washed with DI water. It was then placed back in the bottle along with 120.83 g of aqueous solution containing 20 mg/mL dimethylamine (the amination agent) and 0.5 mg/mL of the tris buffer, adjusted to pH 10 using hydrochloric acid. The bottle was placed on a roller and rolled overnight before removing the membrane, washing several times with DI water, and drying in a vacuum oven at 50° C. The final mass was 27.2 mg, indicating that 1.6 mg of coating remained on the membrane.

After rewetting the membrane with propylene glycol methyl ether acetate (PGMEA), it was placed back inside the filter holder and flushed with a solution of PGMEA spiked with 10 ppb per metal of the custom multi-element standard described in Example 1 at a flow rate of 1.4 g/min. Samples were collected after 5 minutes, 50 minutes, and 125 minutes, and analyzed for metals content using an Agilent 7700 Single Quadrupole inductively coupled plasma-mass spectrometer (ICP-MS), along with a control sample of the spiked PGMEA. The results, in ppb, are shown in Table 7 below.

TABLE 7

| Metal | Control | 5 minutes | 50 minutes | 125 minutes |
|---|---|---|---|---|
| Al | 10.843 | 0.146 | 1.147 | 3.603 |
| Ca | 14.175 | 0.241 | 0.490 | 6.718 |
| Cr | 12.098 | 0.276 | 2.191 | 5.527 |
| Cu | 10.843 | 0.095 | 0.218 | 0.603 |
| Fe | 10.363 | 0.085 | 0.920 | 3.414 |
| Mg | 11.843 | 0.025 | 0.143 | 6.709 |
| Mn | 11.904 | 0.010 | 0.025 | 2.542 |
| Ni | 11.425 | 0.030 | 0.079 | 0.822 |
| K | 14.354 | 0.065 | 10.233 | 12.211 |
| Na | 19.007 | 0.090 | 10.233 | 13.711 |
| Sn | 6.730 | 0.015 | 0.514 | 2.313 |
| Ti | 3.296 | 0.000 | 0.109 | 0.713 |
| Zn | 14.502 | 0.040 | 0.049 | 0.219 |
| TOTAL | 151.383 | 1.118 | 26.351 | 59.105 |

What is claimed is:

1. A filtration membrane comprising:
a porous membrane that comprises a polymer;
a derivatized polydopamine layer disposed on one or both sides of the porous membrane; where the derivatized polydopamine layer is disposed on the porous membrane in the presence of an oxidizing agent.

2. The filtration membrane of claim 1, where the polydopamine layer is derivatized with an amine, a thiol, a carboxylic acid, or a combination thereof.

3. The filtration membrane of claim 1, where the polymer comprises a polyolefin or a fluoropolymer.

4. The filtration membrane of claim 1, where the porous membrane has a nominal pore size of 1 to 5000 nanometers.

5. The filtration membrane of claim 2, wherein the amine is dimethylamine.

6. The filtration membrane of claim 1, where the polydopamine layer has a thickness of 1 to 100 nm.

7. The filtration membrane of claim 1, where the oxidizing agent comprises a periodate, a perchlorate, a persulfate, or a combination thereof.

8. The filtration membrane of claim 1, wherein the periodate is sodium metaperiodate.

9. A method of coating a porous membrane, comprising:
disposing a porous membrane in a solution comprising a dopamine monomer, a buffer, an oxidizing agent and a solvent in a reactor; where the dopamine monomer, the buffer and the oxidizing agent are gradually added to the reactor;
forming a polydopamine layer on the porous membrane; and
derivatizing the polydopamine layer with an amine, a thiol, a carboxylic acid, or a combination thereof.

10. A method of purifying a liquid comprising:
passing a liquid through a filtration membrane; where the filtration membrane comprises:
a porous membrane;
a derivatized polydopamine layer disposed on one or both sides of the porous membrane; where the derivatized polydopamine layer is disposed on the porous membrane in the presence of an oxidizing agent; and
removing ionic and particulate impurities from the liquid.
